(19) United States
(12) Patent Application Publication
(10) Pub. No.: US 2025/0278382 A1
(43) Pub. Date: Sep. 4, 2025

(54) DATA TRANSMITTING METHOD AND DATA TRANSMITTING DEVICE

(71) Applicant: REALTEK SEMICONDUCTOR CORPORATION, HSINCHU (TW)

(72) Inventors: ZHEN-TING HUANG, Hsinchu (TW); TING-WEI LEE, Hsinchu (TW); CHIA-YI CHANG, Hsinchu (TW); ER-ZIH WONG, Hsinchu (TW); SHIH-CHIANG CHU, Hsinchu (TW); CHIA-HUNG LIN, Hsinchu (TW)

(21) Appl. No.: 19/064,777

(22) Filed: Feb. 27, 2025

(30) Foreign Application Priority Data
Mar. 4, 2024 (TW) 113107770

(51) Int. Cl. G06F 13/42

(52) U.S. Cl. CPC G06F 13/4282; G06F 2213/0042

(57) ABSTRACT

A data transmitting method includes following steps: transmitting a stream to a first host stream buffer or a first processor core by a device stream buffer; determining whether the first host stream buffer or the first processor core is full; and if it is determined that the first host stream buffer is full or the first processor core is full, transmitting the stream to a second host stream buffer or a second processor core by a backup device stream buffer.

### BACKGROUND OF THE INVENTION

### 1. Field of the Invention

The present disclosure relates to a data transmitting method and a data transmitting device, especially to a data transmitting method and a data transmitting device that utilize a backup device stream buffer to transmit streams.

### 2. Description of Related Art

During the transmission of stream data, if a processor core (CPU core) or a host stream buffer cannot process the stream data, a universal serial bus (USB) is in a starvation state. Load balancing schemes can be utilized to help balance loads to address the above-mentioned problem. However, the load balancing schemes usually need a passive period to initiate, resulting in the universal serial bus being in a starvation state during the passive period, thereby reducing the utilization of the universal serial bus.

### SUMMARY OF THE INVENTION

In some aspects, an object of the present disclosure is to, but not limited to, provides a data transmitting method and a data transmitting device that makes an improvement to the prior art.

An embodiment of a data transmitting method of the present disclosure includes following steps: transmitting a stream to a first host stream buffer or a first processor core by a device stream buffer; determining whether the first host stream buffer or the first processor core is full; and if it is determined that the first host stream buffer is full or the first processor core is full, transmitting the stream to a second host stream buffer or a second processor core by a backup device stream buffer.

An embodiment of a data transmitting device of the present disclosure includes a memory and a processor. The memory is configured to store at least command. The processor is configured to read the at least command to execute following steps: transmitting a stream to a first host stream buffer or a first processor core by a device stream buffer; determining whether the first host stream buffer or the first processor core is full; and if it is determined that the first host stream buffer is full or the first processor core is full, transmitting the stream to a second host stream buffer or a second processor core by a backup device stream buffer.

Technical features of some embodiments of the present disclosure make an improvement to the prior art. The data transmitting method and the data transmitting device of the present disclosure utilize the backup device stream buffer to transmit streams to solve the problem of a universal serial bus being in a starvation state, thereby enhancing the utilization of the universal serial bus.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a data transmitting device of the present disclosure.

FIG. 2 shows an embodiment of a flow diagram of a data transmitting method of the present disclosure.

FIG. 3 shows an embodiment of a block diagram of a data transmitting device of the present disclosure.

FIG. 4 shows an embodiment of a block diagram of a data transmitting device of the present disclosure.

### DETAILED DESCRIPTION OF THE PREFERRED EMBODIMENTS

To address the problem that a universal serial bus is in a starvation state due to processor cores or host stream buffers being unable to process streams, the present disclosure provides a data transmitting method and a data transmitting device, which will be explained in detail as shown below.

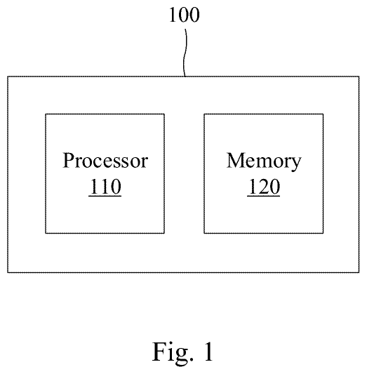

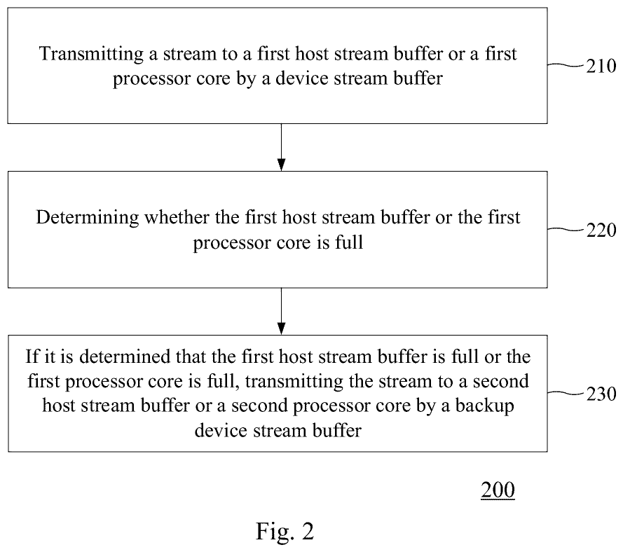

FIG. 1 shows an embodiment of a data transmitting device 100 of the present disclosure. As shown in the figure, the data transmitting device 100 includes a processor 110 and a memory 120. The memory 120 is configured to store at least one command. The processor 110 is configured to read the at least one command to execute a data transmission. For facilitating the understanding of the operations of the data transmitting device 100, reference is now made to FIG. 2. FIG. 2 shows an embodiment of a flow diagram of a data transmitting method 200 of the present disclosure.

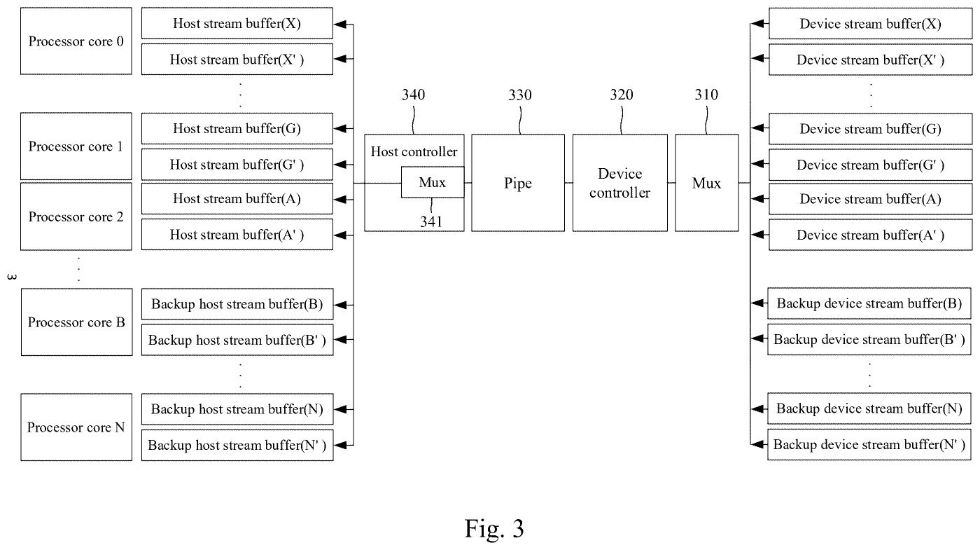

In step 210, transmitting a stream to a first host stream buffer or a first processor core by a device stream buffer. For example, referring to FIG. 3, when the stream needs to be transmitted, the device stream buffer (X) can be utilized to transmit the stream to the host stream buffer (X) or the processor core 0.

In some embodiments, the device stream buffer (X) transmits the stream to a multiplexer 310. The multiplexer 310 transmits the stream to a device controller 320. Subsequently, the device controller 320 transmits the stream to a multiplexer 341 of a host controller 340 through a pipe 330. Furthermore, the multiplexer 341 of the host controller 340 transmits the stream to corresponding host stream buffer (X) or corresponding processor core 0.

In some embodiments, the pipe 330 can be a universal serial bus (USB), and the device stream buffer (X) can transmit the stream to the host stream buffer (X) or the processor core 0 through the universal serial bus.

In step 220, determining whether the first host stream buffer or the first processor core is full. For example, referring to FIG. 3, the present disclosure determines whether the host stream buffer (X) or the processor core 0 is full. If it is determined that the host stream buffer (X) or the processor core 0 is full, the host stream buffer (X) or the processor core 0 is unable to process the stream.

In step 230, if it is determined that the first host stream buffer is full or the first processor core is full, transmitting the stream to a second host stream buffer or a second processor core by a backup device stream buffer. For example, referring to FIG. 3, if it is determined that the host stream buffer (X) is full or the processor core 0 is full, the backup device stream buffer (N) can be utilized to transmit the stream to the host stream buffer (N) or the processor core N.

In view of the above, when the host stream buffer is full or the processor core is full, the data transmitting device 100 and the data transmitting method 200 of the present disclosure can transmit the stream to the host stream buffer which is idle or the processor core which is idle through the backup device stream buffer to solve the problem of a universal serial bus being in a starvation state, thereby enhancing the utilization of the universal serial bus.

In some embodiments, the step 230 further includes the following operations: exchanging a stream identification of the stream to switch a stream transmitting terminal from the device stream buffer to the backup device stream buffer. For example, if the device stream buffer (X) corresponding to the original stream identification (stream ID) transmits the stream, and the stream is unable to be processed by corresponding host stream buffer (X) or corresponding processor core 0, the present disclosure can exchange the stream identification through the mechanism of exchanging (swapping) the stream identification. After exchanging the stream identification, the transmitter of the stream will be switched from the original device stream buffer (X) to the backup device stream buffer (N). In view of the above, the backup device stream buffer (N) can be utilized to transmit the stream to the corresponding host stream buffer (N) or the corresponding processor core N for processing the stream, thereby avoiding a universal serial bus from being in a starvation state and enhancing the utilization of the universal serial bus.

In some embodiments, in step 230, the second host stream buffer can be an idle host stream buffer, and the second processor core can be an idle processor core. In some embodiments, the present disclosure further executes a round robin operation to obtain the second host stream buffer which is idle or the second processor core which is idle. For example, the present disclosure can utilize the round robin mechanism to know whether the host stream buffer (N) or the processor core N is in an idle state.

In some embodiments, the present disclosure can further choose the backup device stream buffer according to a backup look-up table to transmit the stream to the second host stream buffer or the second processor core. For example, if only a hash value (RSS HASH value) is assigned, it is unable to execute an exchange (swap) operation. To address the above-mentioned problem, the present disclosure includes a backup look-up table to provide alternative aggregation manners with different hash values for transmitting the stream to the host stream buffer which is idle or the processor core which is idle.

In some embodiments, the present disclosure can choose the backup device stream buffer according to an interruption state of a bus to transmit the stream to the second host stream buffer or the second processor core. For example, the present disclosure can assign the device stream buffer corresponding to a given stream identification (stream ID) for executing the transmission of the stream according to the interruption state (USB Host PCIE Interrupt) of the bus, thereby transmitting the stream to the host stream buffer which is idle or the processor core which is idle.

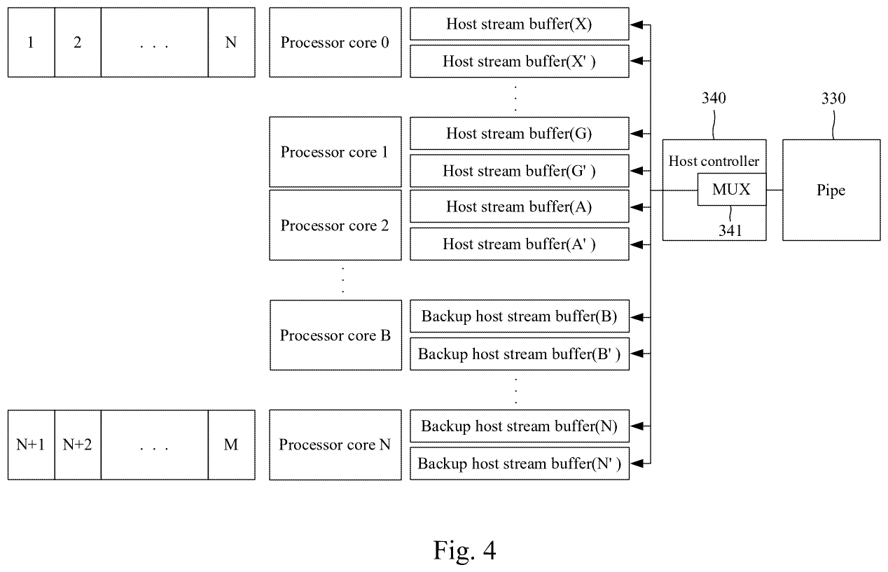

In some embodiments, the present disclosure can transmit a first portion sub-stream of the stream to the first host stream buffer or the first processor core by the device stream buffer, and transmit a second portion sub-stream of the stream to the second host stream buffer or the second processor core by the backup device stream buffer. Reference is made to FIG. 4, for example, the device stream buffer (X) transmits the first portion sub-streams 1˜N of the stream to the host stream buffer (X) or the processor core 0, and the backup device stream buffer (N) transmits the second portion sub-streams N+1˜M of the stream to the host stream buffer (N) or the processor core N. In some embodiments, the present disclosure may include only one set of the backup device stream buffer and the backup host stream buffer, for example, the present disclosure may only include the backup device stream buffer (N) and the backup host stream buffer (N) to reduce costs.

In some embodiments, the present disclosure can reorder the first portion sub-stream and the second portion sub-stream of the stream to conform to a stream sequence. Reference is made to FIG. 4, for example, the present disclosure can utilize the device stream buffer (X) and the backup device stream buffer (N) to respectively transmit the first portion sub-streams 1˜N and the second portion sub-streams N+1˜M of the stream to the host stream buffer (X), the backup host stream buffer (N), or the processor cores 0, N for maintaining the utilization of the universal serial bus. Subsequently, the present disclosure reorders the first portion sub-streams 1˜N and the second portion sub-streams N+1˜M to conform to a stream sequence (in order). In view of the above, even if the latter sub-streams (such as packets) have been transmitted in advance, the present disclosure can wait for the former sub-streams (such as packets) which is jammed to be transmitted, and the whole sub-streams are then reordered to conform to the stream sequence for facilitating subsequent stream processing.

In some embodiments, the above-mentioned reordering operation can be implemented by the device end (such as by a device driver), or by the host end (such as by a host controller driver, a filter driver, and so on). It should be noted that due to a turnaround time of a universal serial bus being much greater than the above-mentioned reordering time, the time taken for the reordering operation in the present disclosure can be almost ignored. Additionally, the above-mentioned operation, for the network stack of the higher-level operating system (OS), is merely a series of stream packets being continuously delivered. The present disclosure only implements this operation at the lower level together with the former stream which is jammed and the backup stream.

In some embodiments, if it is determined that the first host stream buffer is full or the first processor core is full, the present disclosure can utilize a plurality of backup device stream buffers to respectively transmit a plurality of sub-streams of the stream to a plurality of second host stream buffers or a plurality of second processor cores at different time points. For example, if it is determined that the host stream buffer (X) is full or the processor core 0 is full, the present disclosure can utilize a plurality of backup device stream buffers (B), (N) to respectively transmit a plurality of sub-streams to a plurality of host stream buffers (B), (N) or a plurality of processor cores B, N at different time points. However, the present disclosure is not limited to the above-mentioned embodiment. In another embodiment, the present disclosure also can utilize a plurality of backup device stream buffers (B), (N) to transmit a plurality of sub-streams to a plurality of host stream buffers (B), (N) or a plurality of processor cores B, N at the same time based on actual requirements.

It is noted that the present disclosure is not limited to the embodiments as shown in FIG. 1 to FIG. 4, it is merely an example for illustrating one of the implements of the present disclosure, and the scope of the present disclosure shall be defined on the bases of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The data transmitting device 100 and the data transmitting method 200 of the present disclosure utilize the backup device stream buffer to transmit streams to solve the problem of a universal serial bus being in a starvation state, thereby enhancing the utilization of the universal serial bus.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A data transmitting method, executed by a processor reading at least one command stored in a memory, comprising:
transmitting a stream to a first host stream buffer or a first processor core by a device stream buffer;
determining whether the first host stream buffer or the first processor core is full; and
if it is determined that the first host stream buffer is full or the first processor core is full, transmitting the stream to a second host stream buffer or a second processor core by a backup device stream buffer.

2. The data transmitting method of claim 1, wherein transmitting the stream to the second host stream buffer or the second processor core by the backup device stream buffer comprises:
exchanging a stream identification of the stream to switch a stream transmitting terminal from the device stream buffer to the backup device stream buffer, and transmitting the stream to the second host stream buffer or the second processor core by the backup device stream buffer.

3. The data transmitting method of claim 1, wherein the second host stream buffer comprises an idle host stream buffer, and the second processor core comprises an idle processor core.

4. The data transmitting method of claim 1, further comprising:
executing a round robin operation to obtain the second host stream buffer which is idle or the second processor core which is idle.

5. The data transmitting method of claim 1, further comprising:
choosing the backup device stream buffer according to a backup look-up table to transmit the stream to the second host stream buffer or the second processor core.

6. The data transmitting method of claim 1, wherein transmitting the stream to the second host stream buffer or the second processor core by the backup device stream buffer comprises:
choosing the backup device stream buffer according to an interruption state of a bus to transmit the stream to the second host stream buffer or the second processor core.

7. The data transmitting method of claim 1, wherein transmitting the stream to the first host stream buffer or the first processor core by the device stream buffer comprises:
transmitting a first portion sub-stream of the stream to the first host stream buffer or the first processor core by the device stream buffer;
wherein transmitting the stream to the second host stream buffer or the second processor core by the backup device stream buffer comprises:
transmitting a second portion sub-stream of the stream to the second host stream buffer or the second processor core by the backup device stream buffer.

8. The data transmitting method of claim 7, further comprising:
reordering the first portion sub-stream and the second portion sub-stream to conform to a stream sequence.

9. The data transmitting method of claim 1, wherein transmitting the stream to the second host stream buffer or the second processor core by the backup device stream buffer comprises:
respectively transmitting a plurality of sub-streams of the stream to a plurality of second host stream buffers or a plurality of second processor cores at different time points by a plurality of backup device stream buffers.

10. The data transmitting method of claim 1, wherein transmitting the stream to the first host stream buffer or the first processor core by the device stream buffer comprises:
transmitting the stream to the first host stream buffer or the first processor core through a universal serial bus by the device stream buffer.

11. A data transmitting device, comprising:
a memory, configured to store at least one command; and
a processor, configured to read the at least one command to execute following steps:
transmitting a stream to a first host stream buffer or a first processor core by a device stream buffer;
determining whether the first host stream buffer or the first processor core is full; and
if it is determined that the first host stream buffer is full or the first processor core is full, transmitting the stream to a second host stream buffer or a second processor core by a backup device stream buffer.

12. The data transmitting device of claim 11, wherein transmitting the stream to the second host stream buffer or the second processor core by the backup device stream buffer, which is executed by the processor reading the at least one command, comprises:
exchanging a stream identification of the stream to switch a stream transmitting terminal from the device stream buffer to the backup device stream buffer, and transmitting the stream to the second host stream buffer or the second processor core by the backup device stream buffer.

13. The data transmitting device of claim 11, wherein the second host stream buffer comprises an idle host stream buffer, and the second processor core comprises an idle processor core.

14. The data transmitting device of claim 11, wherein the processor is further configured to read the at least one command to execute following step:
executing a round robin operation to obtain the second host stream buffer which is idle or the second processor core which is idle.

15. The data transmitting device of claim 11, the processor is further configured to read the at least one command to execute following step:
choosing the backup device stream buffer according to a backup look-up table to transmit the stream to the second host stream buffer or the second processor core.

16. The data transmitting device of claim 11, wherein transmitting the stream to the second host stream buffer or the second processor core by the backup device stream buffer, which is executed by the processor reading the at least one command, comprises:
choosing the backup device stream buffer according to an interruption state of a bus to transmit the stream to the second host stream buffer or the second processor core.

17. The data transmitting device of claim 11, wherein transmitting the stream to the first host stream buffer or the first processor core by the device stream buffer, which is executed by the processor reading the at least one command, comprises:
transmitting a first portion sub-stream of the stream to the first host stream buffer or the first processor core by the device stream buffer;
wherein transmitting the stream to the second host stream buffer or the second processor core by the backup device stream buffer, which is executed by the processor reading the at least one command, comprises:
transmitting a second portion sub-stream of the stream to the second host stream buffer or the second processor core by the backup device stream buffer.

18. The data transmitting device of claim 17, wherein the processor is further configured to read the at least one command to execute following step:
reordering the first portion sub-stream and the second portion sub-stream to conform to a stream sequence.

19. The data transmitting device of claim 11, wherein transmitting the stream to the second host stream buffer or the second processor core by the backup device stream buffer, which is executed by the processor reading the at least one command, comprises:
respectively transmitting a plurality of sub-streams of the stream to a plurality of second host stream buffers or a plurality of second processor cores at different time points by a plurality of backup device stream buffers.

20. The data transmitting device of claim 11, wherein transmitting the stream to the first host stream buffer or the first processor core by the device stream buffer, which is executed by the processor reading the at least one command, comprises:
transmitting the stream to the first host stream buffer or the first processor core through a universal serial bus by the device stream buffer.
